(19) United States
(12) Patent Application Publication
(10) Pub. No.: US 2024/0424997 A1
(43) Pub. Date: Dec. 26, 2024

(54) ELECTRONIC PRODUCT HOLDER AND RETAINING PORTION INTEGRATED STRUCTURE

(71) Applicant: Fan Yu, Shenzhen (CN)

(72) Inventor: Fan Yu, Shenzhen (CN)

(21) Appl. No.: 18/827,886

(22) Filed: Sep. 9, 2024

Related U.S. Application Data
(63) Continuation-in-part of application No. PCT/CN2023/098042, filed on Jun. 2, 2023.

(30) Foreign Application Priority Data
Jun. 10, 2022 (CN) 202221444098.6

(51) Int. Cl. B60R 11/02; B60R 11/00

(52) U.S. Cl. CPC B60R 11/02; B60R 2011/0057; B60R 2011/0063; B60R 2011/008

(57) ABSTRACT

An electronic product holder and retaining portion integrated structure includes a metal flexible member having a retaining portion and a holder integrally extending outward from the retaining portion. An adapter is connected to one end of the holder opposite the retaining portion. A retaining device attachable to a surface of an object is provided on one side of the retaining portion. The production costs and assembly labor hours of parts and materials required for such products are reduced, while reducing the failure rate of products in use.

### CROSS REFERENCE TO RELATED APPLICATIONS

This is a continuation-in-part application of PCT Application No. PCT/CN2023/098042, “HOLDER SUPPORTING BASE AND HOLDER” filed on Jun. 2, 2023, claiming the benefit of Chinese Patent Application No. 202221444098.6 filed on Jun. 10, 2022.

### BACKGROUND OF THE INVENTION

### 1. Field of the Invention

The present invention relates to a holder, and more particularly to an electronic product holder and retaining portion integrated structure.

### 2. Description of the Prior Art

A holder and a retaining base are used for holding an electronic product through an adapter and a retaining device. The retaining base is configured to secure the holder used for holding the electronic product.

Taking a vehicle-mounted holder as an example, in general, a suction cup is disposed under the bottom of the retaining base of the vehicle-mounted holder. The vehicle-mounted holder is attached to the dashboard or windshield of a vehicle through the suction cup. The vehicle may bump on the road, which will cause the suction cup to fall off from the dashboard or windshield easily, causing inconvenience to the driver.

In these days, adhesive is provided on the bottom of the supporting base of the vehicle-mounted holder for sticking the supporting base of the vehicle-mounted holder on the dashboard. However, since the bottom plate of the supporting base is a horizontal surface and the dashboard is a curved surface with a certain curvature, a gap is formed between the bottom plate and the dashboard, which results in poor stability of the adhesive connection. A curved base plate is developed to fit the curved surface of the dashboard. However, due to some differences in the dashboards of vehicles, resulting in that the curved bottom plate is unable to fit well to different vehicles and is less versatile.

At the international preliminary examination stage of the PCT Application No. PCT/CN2023/098042, the examiner deems that the cited reference D1 KR200245259Y1 affects the novelty and non-obviousness of this PCT application. However, as disclosed in the description, abstract and FIG. 5 of the cited reference KR200245259Y1, the metal strap and the rubber plate 1 of the cited reference KR200245259Y1 are related to a mobile phone holder installation device that can be secured on a curved dashboard. Its flexible structure serves only how it is held in place.

The examiner deems that the cited reference D3 CN201521772U affects the non-obviousness of claim 10 of this PCT application. However, as disclosed in the description, abstract and FIG. 4 of the cited reference CN201521772U, the metal weight unit and the covering unit 2 of the cited reference CN201521772U are related to a soft cushion seat for placing a mobile phone holder, which can be secured on a curved dashboard after adjusting the curvature in advance. Its flexible structure serves only how it is held in place.

The holders as disclosed in the aforementioned prior arts all have deficiencies. As disclosed in the cited reference D1 KR200245259Y1, because the holder 3 is too short in length, it restricts the distance and angle from the user's eyes to the screen of the electronic product, so it will have bad use effects when changing drivers. As disclosed in the cited reference CN201521772U, in order to extend and adjust the distance and angle from the user's eyes to the screen of the electronic product easily, it is necessary to connect an external rotatable pole 4 to optimize the user experience. However, this not only increases the cost of production and assembly but also increases the failure rate of the product.

### SUMMARY OF THE INVENTION

In view of the deficiencies of the prior art, the primary object of the present invention is to provide an electronic product holder and retaining portion integrated structure having a bendable metal flexible member. The metal flexible member includes a retaining portion and a holder integrally extending outward from the retaining portion. When the product of the present invention is to be attached to a curved dashboard, after the curvature of the retaining portion is pre-adjusted, the retaining portion of the electronic product holder and retaining portion integrated structure is attached to the dashboard through a retaining device. The user can adjust the curvature and angle of the holder by twisting or bending the holder as needed to get the right distance and angle from the user's eyes to the screen of the electronic product. For the next user, only the curvature and angle of the holder are readjusted as needed, and there is no need to adjust the retaining portion. The present invention has better versatility.

In order to achieve the foregoing object, the present invention adopts the following technical solutions:

An electronic product holder and retaining portion integrated structure comprises a metal flexible member having a retaining portion and a holder integrally extending outward from the retaining portion. An adapter being connected to one end of the holder opposite the retaining portion. A retaining device attachable to a surface of an object is provided on one side of the retaining portion. The metal flexible member is fully or partially covered with a flexible rubber.

Compared with the prior art, the present invention has obvious advantages and beneficial effects. Specifically, it can be known from the above technical solutions:

The metal flexible member includes the retaining portion and the holder integrally extending outward from the retaining portion. When the product of the present invention is to be attached to a curved dashboard, after the curvature of the retaining portion is pre-adjusted, the retaining portion of the electronic product holder and retaining portion integrated structure is attached to the dashboard through the retaining device. The user can adjust the curvature and angle of the holder by twisting or bending the holder as needed to get the right distance and angle from the user's eyes to the screen of the electronic product. For the next user, only the curvature and angle of the holder are readjusted as needed, and there is no need to adjust the retaining portion. The present invention has better versatility. The metal flexible member is fully or partially covered with the flexible rubber, playing a role in protecting the human body and the car body.

Furthermore, the retaining device may be an adhesive device, a Velcro® device or a magnetic device.

These and/or other aspects will become apparent and more readily appreciated from the following description of the embodiments, taken in conjunction with the accompanying drawings, in which:

### BRIEF DESCRIPTION OF THE DRAWINGS

FIG. 1 is a perspective view of a first embodiment of the present invention (in a flat state);

FIG. 2 is a cross-sectional view of the first embodiment of the present invention;

FIG. 3 is a schematic view of a second embodiment of the present invention (in a flat state), wherein the metal flexible member is covered with the flexible member;

FIG. 4 is a schematic view of the second embodiment of the present invention, wherein the holder is bent;

FIG. 5 is a schematic view of the second embodiment of the present invention when in use;

FIG. 6 is a schematic view of FIG. 5 of the prior art KR200245259Y1; and

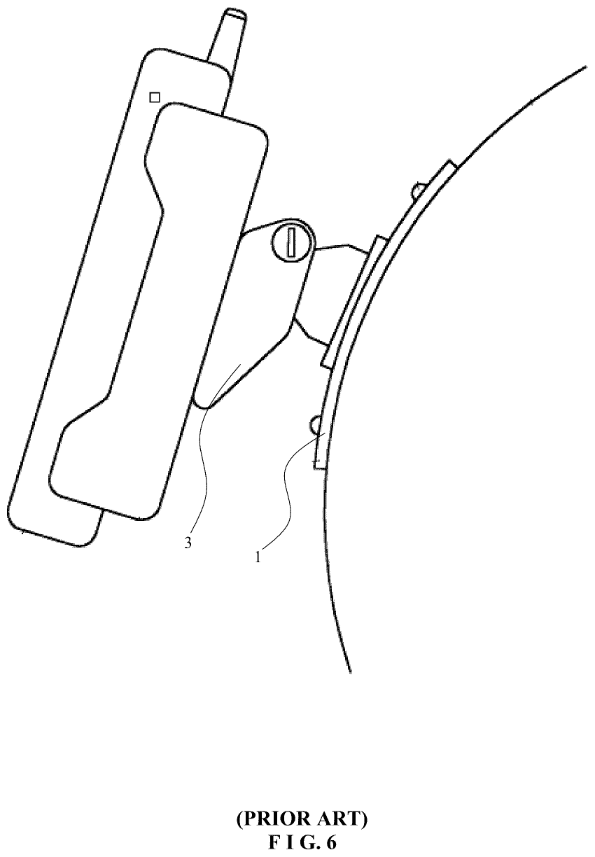

FIG. 7 is a schematic view of FIG. 4 of the prior art CN2015217720.

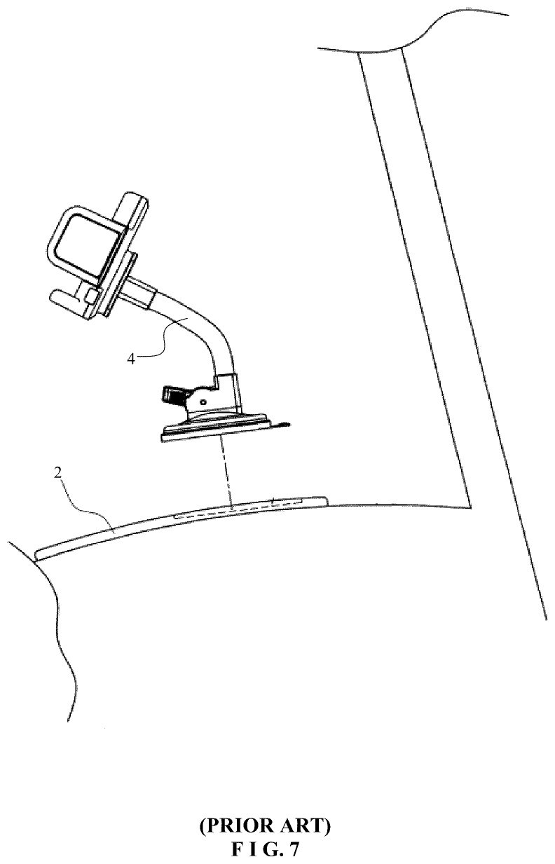

### DETAILED DESCRIPTION OF THE PREFERRED EMBODIMENTS

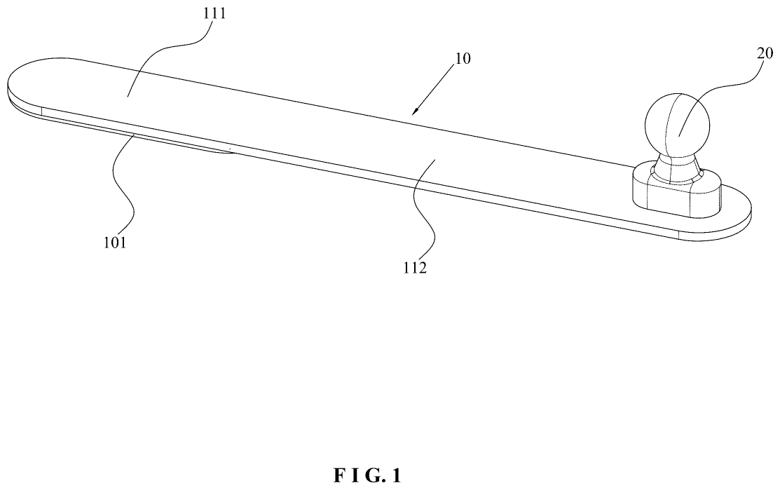

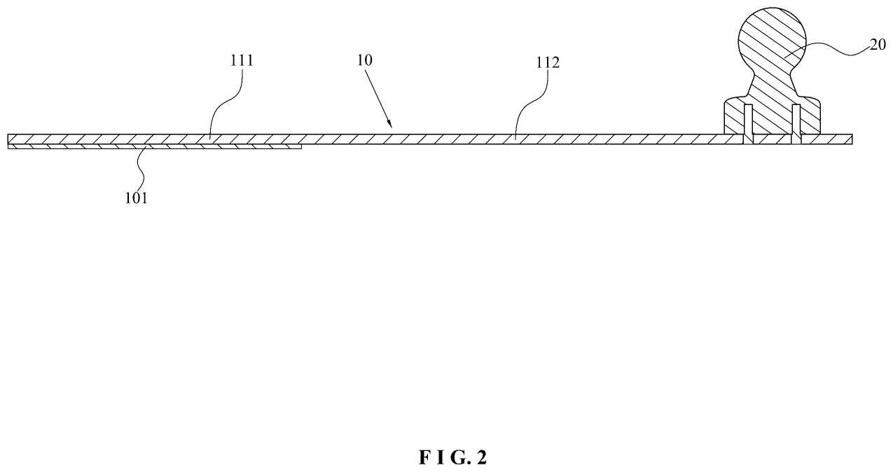

FIG. 1 and FIG. 2 show the specific structure of a first embodiment of the present invention, comprising an electronic product holder and retaining portion integrated structure 10 and an adaptor 20 for connecting an external electronic product.

The electronic product holder and retaining portion integrated structure 10 includes a metal flexible member 11 having a retaining portion 111 and a holder 112 integrally extending outward from the retaining portion 111. The adapter 20 is connected to one end of the holder 112 opposite the retaining portion 111. A retaining device 101 attachable to the surface of an object is provided on one side of the retaining portion 111.

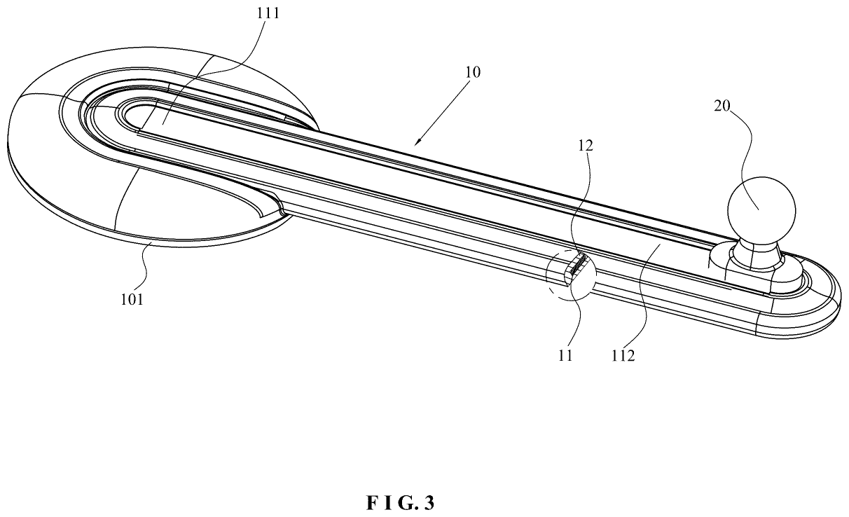

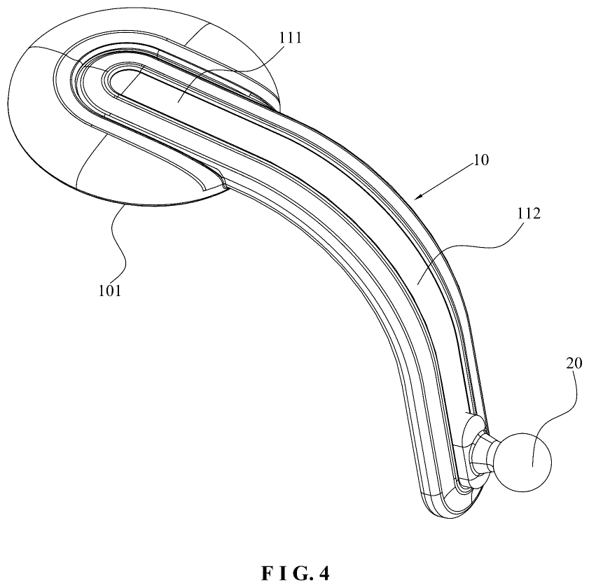

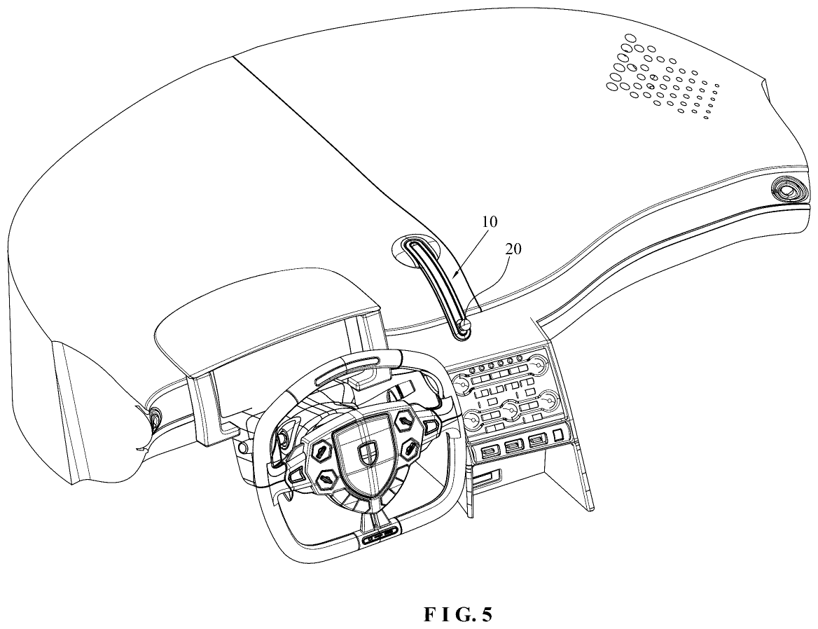

Referring to FIG. 3 through FIG. 5, the retaining portion 111 and the holder 112 of the metal flexible member 11 are covered with a flexible rubber 12, except the adapter 20 protruding outwardly.

The feature of the present invention is described below.

The metal flexible member 11 includes the retaining portion 111 and the holder 112 integrally extending outward from the retaining portion 111. When the product of the present invention is to be attached to a curved dashboard, after the curvature of the retaining portion 111 is pre-adjusted, the retaining portion 111 of the electronic product holder and retaining portion integrated structure 10 is attached to the dashboard through the retaining device 101. The user can adjust the curvature and angle of the holder 112 by twisting or bending the holder 112 as needed to get the right distance and angle from the user's eyes to the screen of the electronic product. For the next user, there is no need to adjust the retaining portion 111, and only the curvature and angle of the holder 112 are readjusted as needed. The flexible rubber 12 covering the metal flexible member 11 plays a role in protecting the human body and the car body.

The metal flexible member 11 is fully or partially covered with the flexible rubber 12.

Furthermore, the retaining device 101 may be an adhesive device, a Velcro® device or a magnetic device.

What is claimed is:

1. An electronic product holder and retaining portion integrated structure, comprising a metal flexible member having a retaining portion and a holder integrally extending outward from the retaining portion, an adapter being connected to one end of the holder opposite the retaining portion, a retaining device attachable to a surface of an object being provided on one side of the retaining portion.

2. The electronic product holder and retaining portion integrated structure as claimed in claim 1, wherein the retaining device is one of an adhesive device, a Velcro® device and a magnetic device.

3. The electronic product holder and retaining portion integrated structure as claimed in claim 1, wherein the metal flexible member is fully or partially covered with a flexible rubber.

4. The electronic product holder and retaining portion integrated structure as claimed in claim 3, wherein the side of the retaining portion, having the retaining device, is covered with the flexible rubber.

5. The electronic product holder and retaining portion integrated structure as claimed in claim 3, wherein an area of the retaining portion covered with the flexible rubber is greater than a bottom area of the retaining portion.

6. The electronic product holder and retaining portion integrated structure as claimed in claim 5, wherein the side of the retaining portion, having the retaining device, is covered with the flexible rubber, and an area of the retaining device is greater than the bottom area of the retaining portion.
